(19) United States
(12) Patent Application Publication
(10) Pub. No.: US 2016/0244891 A1
(43) Pub. Date: Aug. 25, 2016

(54) SOLDER BALL FOR FLUXLESS BONDING, METHOD OF MANUFACTURING THE SAME, AND METHOD OF FORMING SOLDER BUMP

(71) Applicant: MK ELECTRON CO., LTD., Gyeonggi-do (KR)

(72) Inventors: Jae Yeol SON, Gyeonggi-do (KR); Jeong Tak MOON, Gyeonggi-do (KR); Jae Hun SONG, Gyeonggi-do (KR); Young Woo LEE, Incheon (KR); Eung Jae KIM, Daegu (KR); Ik Joo MAENG, Gyeonggi-do (KR); Chan Goo YOO, Gyeonggi-do (KR)

(73) Assignee: MK ELECTRON CO., LTD., Gyeonggi-do (KR)

(21) Appl. No.: 15/050,708

(22) Filed: Feb. 23, 2016

(30) Foreign Application Priority Data
Feb. 25, 2015 (KR) 1020150026734
Feb. 3, 2016 (KR) 1020160013531

(51) Int. Cl. C25D 3/12; C25D 5/12; C25D 7/00; C23C 18/16; B23K 35/02; B23K 35/26; B23K 35/22; C23C 18/31; C25D 3/48; B23K 1/00

(52) U.S. Cl. CPC C25D 3/12; C25D 3/48; C25D 5/12; C25D 7/00; B23K 1/0006; B23K 35/0244; B23K 35/262; B23K 35/226; C23C 18/31; C23C 18/1633

(57) ABSTRACT

A solder ball for fluxless bonding includes a solder core, a first metal layer on a surface of the solder core, and a second metal layer on the first metal layer. The first metal layer includes at least one of nickel (Ni), silver (Ag), zinc (Zn), tin (Sn), chrome (Cr), antimony (Sb), platinum (Pt), palladium (Pd), aluminum (Al), or an alloy thereof. The second metal layer includes gold (Au). As the above solder ball for fluxless bonding is in use, a solder bump having high reliability may be formed via a relatively short, low cost, and simple process.

### RELATED APPLICATIONS

This application claims the benefit of Korean Patent Applications No. 10-2015-0026734, filed on Feb. 25, 2015, and No. 10-2016-0013531, filed on Feb. 3, 2016, in the Korean Intellectual Property Office, the disclosures of which are incorporated herein in its entirety by reference.

### BACKGROUND OF THE INVENTION

1. Field of the Invention

One or more embodiments relate to a solder ball for fluxless bonding, a method of manufacturing the solder ball for fluxless bonding, and a method of forming a solder bump, and more particularly, to a solder ball for fluxless bonding, a method of manufacturing the solder ball for fluxless bonding, and a method of forming a solder bump with high reliability via a relatively short, low cost, and simple process.

2. Description of the Related Art

When a solder ball is bonded through a reflow process, a flux is used to remove a native oxide layer from a surface of the solder ball. However, the flux that has been used is not completely removed even after a cleaning process and may corrode, thereby degrading the reliability of a semiconductor device. Furthermore, the flux is expensive so that the unit cost of semiconductor devices increases.

In addition, a tool for dotting flux is used when pick-up equipment is used to accommodate a solder ball on a substrate. In this regard, the tool needs to be periodically cleaned, which is one of the reasons for equipment downtime.

### SUMMARY OF THE INVENTION

One or more embodiments include a solder ball for forming a solder bump having high reliability via a relatively short, low cost, and simple process.

One or more embodiments include a method of manufacturing a solder ball for forming a solder bump having high reliability via a relatively short, low cost, and simple process.

One or more embodiments include a method of forming a solder bump by using the above solder ball.

Additional aspects will be set forth in part in the description which follows and, in part, will be apparent from the description, or may be learned by practice of the presented embodiments.

According to one or more embodiments, a solder ball for fluxless bonding includes a solder core, a first metal layer on a surface of the solder core, and a second metal layer on the first metal layer, wherein the first metal layer includes at least one of nickel (Ni), silver (Ag), zinc (Zn), tin (Sn), chrome (Cr), antimony (Sb), platinum (Pt), palladium (Pd), aluminum (Al), or an alloy thereof, and wherein the second metal layer includes gold (Au).

A sum of a thickness of the first metal layer and a thickness of the second metal layer may be equal to or greater than about 0.01 μm and less than about 1 μm.

The thickness of the second metal layer may be equal to or greater than about 0.005 μm and equal to or less than about 0.9 μm.

A melting point of the solder core may range from about 180° C. to about 250° C.

The solder ball for fluxless bonding may further include a support core ball inside the solder core.

The support core ball may include a material that is not melted at a temperature of equal to or less than about 300° C.

According to one or more embodiments, a method of manufacturing a solder ball for fluxless bonding includes providing a solder core, forming a first metal layer on the solder core, and forming a second metal layer on the first metal layer, wherein the first metal layer includes at least one of nickel (Ni), silver (Ag), zinc (Zn), tin (Sn), chrome (Cr), antimony (Sb), platinum (Pt), palladium (Pd), aluminum (Al), or an alloy thereof, and wherein the second metal layer includes gold (Au).

The method may further include treating a surface of the solder core using acid, before the forming of the first metal layer.

A sum of a thickness of the first metal layer and a thickness of the second metal layer may be equal to or greater than about 0.01 μm and less than about 1 μm.

The forming of the first metal layer and the forming of the second metal layer may be performed by electrolytic plating or electroless plating.

According to one or more embodiments, a method of forming a solder bump includes providing a substrate having a bonding pad, providing a solder ball for fluxless bonding on the bonding pad, and reflowing the solder ball for fluxless bonding, wherein the solder ball for fluxless bonding includes a solder core, a first metal layer on a surface of the solder core, and a second metal layer on the first metal layer, wherein the first metal layer includes at least one of nickel (Ni), silver (Ag), zinc (Zn), tin (Sn), chrome (Cr), antimony (Sb), platinum (Pt), palladium (Pd), aluminum (Al), or an alloy thereof, and wherein the second metal layer includes gold (Au).

During the forming of the solder bump, flux for removing a native oxide layer may not be applied to the solder ball.

The reflowing of the solder ball for fluxless bonding may be performed at a temperature ranging from about 180° C. to about 300° C. for about 1 second to about 1 minute.

The solder bump may be formed during reflowing of the solder ball for fluxless bonding even without a pre-heating period.

The reflowing of the solder ball for fluxless bonding may include increasing a temperature of the solder ball from room temperature to a reflow temperature, and wherein the temperature of the solder ball linearly increases from the room temperature to the reflow temperature in time or follows a profile having an upwardly convex shape.

According to one or more embodiments, a solder ball for fluxless bonding includes a solder core and an anti-oxidation metal layer on a surface of the solder core, wherein the anti-oxidation metal layer is a gold (Au) layer having a thickness equal to or greater than about 0.01 μm and less than about 1 μm.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic side cross-sectional view illustrating a solder ball for fluxless bonding according to an embodiment;

FIG. 2 is a schematic side cross-sectional view of a solder ball for fluxless bonding according to another embodiment;

FIG. 3 is a flowchart of a method of manufacturing a solder ball for fluxless bonding according to an embodiment;

FIG. 4 is a flowchart of a method of forming a solder bump according to an embodiment;

FIGS. 5A and 5B are side cross-sectional views for illustrating a method of forming a solder bump according to an embodiment;

FIG. 6 is a graph showing a reflow temperature profile when using a solder ball for fluxless bonding according to an embodiment and a reflow temperature profile when using a solder ball according to the related art;

FIGS. 7A and 7B are images of solder balls according to Example 1, Comparative Example 1, and Comparative Example 2, during a dwell time in a reflow process and after cooling;

FIG. 8 is an image showing that solder balls, according to an embodiment, arranged on a bonding pad are normally accommodated as solder bumps after reflow; and

FIG. 9 is a conceptual diagram of profiles of a proper example of a reflowed solder ball and an improper example of a reflowed solder ball.

### DETAILED DESCRIPTION OF THE PREFERRED EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As the inventive concept allows for various changes and numerous embodiments, embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope of the present inventive concept are encompassed in the present inventive concept. In the description of the present inventive concept, certain detailed explanations of the related art are omitted when it is deemed that they may unnecessarily obscure the essence of the inventive concept.

While such terms as “first,” “second,” etc., may be used to describe various components, such components must not be limited to the above terms. The above terms are used only to distinguish one component from another. For example, without departing from the right scope of the present inventive concept, a first constituent element may be referred to as a second constituent element, and vice versa.

The terms used in the present specification are merely used to describe embodiments, and are not intended to limit the present inventive concept. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless defined otherwise, all terms used herein including technical or scientific terms have the same meanings as those generally understood by those of ordinary skill in the art to which the present inventive concept may pertain. The terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

In the accompanying drawings, the illustrated shapes may be modified according to, for example, manufacturing technology and/or tolerance. Thus, the embodiment of the present inventive concept may not be construed to be limited to a particular shape of a part described in the present specification and may include a change in the shape generated during manufacturing, for example. The term “and/or” shall be understood to include any and all combinations of one or more of the associated listed items. Furthermore, the term “substrate” used herein may denote a substrate itself or a stack structure including a substrate and a certain layer or film formed thereon. Furthermore, in the present specification, “a surface of a substrate” may refer to an exposed surface of the substrate or an outer surface of a certain layer or film formed on the substrate.

A “main component” denotes a component that takes the highest atomic % of all components of a material.

The present inventive concept provides a solder ball for fluxless bonding that sequentially includes a first metal layer and a second metal layer on a solder core. The expression of “for fluxless bonding” signifies that a use of flux to remove a native oxide layer existing on a surface of a conductor is unnecessary when a substrate and a semiconductor device, a substrate and a substrate, or a semiconductor device and a semiconductor device are physically connected to each other using the solder ball.

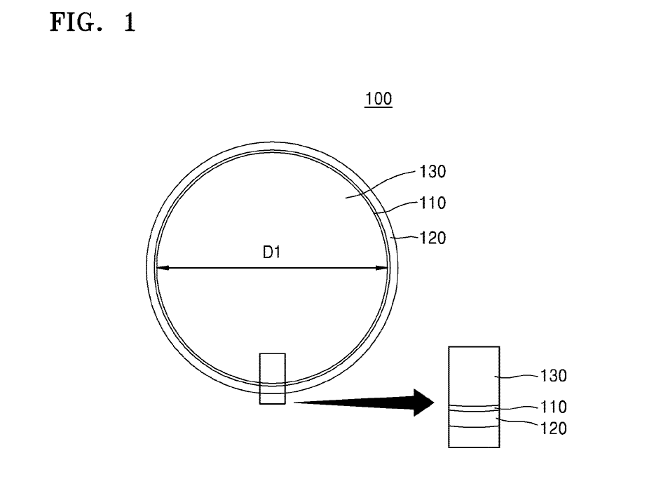

FIG. 1 is a schematic side cross-sectional view illustrating a solder ball 100 for fluxless bonding according to an embodiment.

Referring to FIG. 1, the solder ball 100 for fluxless bonding may include a first metal layer 110 on a solder core 130 and a second metal layer 120 on the first metal layer 110.

The solder core 130 is not particularly limited, and may be any solder composition that can be used for soldering of an electrical part. The solder core 130 may include, for example, a tin (Sn)-nickel (Ni) alloy, an Sn-bismuth (Bi) alloy, an Sn-silver (Ag)-copper (Cu) alloy, an Sn—Bi—Ag alloy, an Sn—Cu alloy, an Sn-zinc (Zn) alloy, an Sn-antimony (Sb) alloy, an Sn—Ag alloy, an Sn—Ag—Cu—Bi alloy, an Sn—Zn—Bi alloy, an Sn—Ag—Cu—Sb alloy, an Sn—Ag-gold (Au) alloy, an Au—Sb alloy, an Au-indium (In) alloy, an Sn—Ag—Bi—In alloy, a Zn—Al alloy, an Au-germanium (Ge)—Sn alloy, or a Bi—Sb alloy, but the present disclosure is not limited thereto. In some embodiments, the solder core 130 may be a tin-based solder core having tin as a main component.

A melting point of the solder core 130 may be about 180° C. to about 250° C. When the melting point of the solder core 130 is not constant, a melting state may be achieved within a temperature range of about 180° C. to about 300° C.

The solder core 130 may have a diameter D1 of about 100 μm to about 800 μm. In some embodiments, the diameter D1 of the solder core 130 may be, for example, about 100 μm to about 500 μm. In some embodiments, the diameter D1 of the solder core 130 may be, for example, about 200 μm to about 400 μm.

The first metal layer 110 may be provided on the solder core 130. The first metal layer 110 may be formed directly on the solder core 130 or above the solder core 130 with another material layer interposed therebetween. The first metal layer 110 may consist of metal, for example, nickel (Ni), silver (Ag), zinc (Zn), tin (Sn), chrome (Cr), antimony (Sb), platinum (Pt), palladium (Pd), or aluminum (Al).

The thickness of the first metal layer 110 may be, for example, about 0.002 μm to about 0.1 μm.

If the thickness of the first metal layer 110 is too thin, a surface of the solder core 130 may be partially exposed. The first metal layer 110 facilitates adhesion of the second metal layer 120 to the surface of the solder core 130. Accordingly, when the surface of the solder core 130 is exposed to the outside of the first metal layer 110, the second metal layer 120 may not properly adhere to the solder core 130.

In contrast, if the thickness of the first metal layer 110 is too thick, dissolution of the first metal layer 110 and/or the second metal layer 120 with the solder core 130 during reflow may incompletely occur.

The second metal layer 120 may be provided on the first metal layer 110. The second metal layer 120 may be formed directly on the first metal layer 110. The second metal layer 120 may be gold (Au) or palladium (Pd). The second metal layer 120 may be a metal different from the first metal layer 110. The second metal layer 120 may be gold (Au). However, the present disclosure is not limited thereto.

The thickness of the second metal layer 120 may be about 0.005 μm to about 0.9 μm.

If the thickness of the second metal layer 120 is too thin, there may be exposed portions on the surfaces of the solder core 130 and/or the first metal layer 110. The second metal layer 120 may function as an anti-oxidation metal layer to prevent forming of native oxide of the solder core 130 and/or the first metal layer 110 due to oxygen in the air. Accordingly, when the surfaces of the solder core 130 and/or the first metal layer 110 are exposed to the outside of the second metal layer 120, the surfaces may be discolored and a bonding force with respect to a pad may be reduced due to the native oxide layer.

In contrast, if the thickness of the second metal layer 120 is too thick, dissolution of the first metal layer 110 and/or the second metal layer 120 with the solder core 130 during reflow may incompletely occur.

A sum of the thickness of the first metal layer 110 and the thickness of the second metal layer 120 may be equal to or greater than about 0.01 μm and less than about 1 μm. If the sum of the thickness of the first metal layer 110 and the thickness of the second metal layer 120 is less than about 0.01 μm, an effect of no need to use flux when the solder ball 100 is used may be reduced. If the sum of the thickness of the first metal layer 110 and the thickness of the second metal layer 120 is equal to or greater than about 1 μm, the solder ball 100 may be weakly bonded, or may not be bonded, to a conductive pad.

In some embodiments, while the first metal layer 110 is omitted, only the second metal layer 120 may exist. In this case, the second metal layer 120 may have a thickness of equal to or greater than about 0.01 μm and less than about 1 μm.

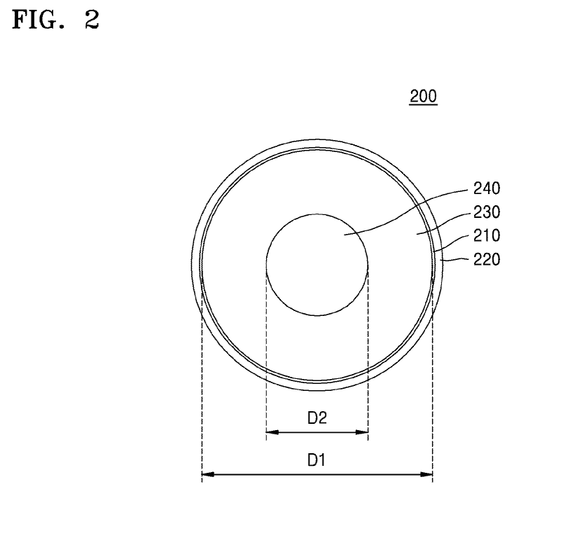

FIG. 2 is a side cross-sectional view of a solder ball 200 for fluxless bonding according to another embodiment.

Referring to FIG. 2, the solder ball 200 for fluxless bonding may sequentially include a first metal layer 210 and a second metal layer 220 on a solder core 230. Furthermore, the solder ball 200 for fluxless bonding may further include a support core ball 240 inside the solder core 230.

The support core ball 240 may be formed of a general metal or an organic material, or an organic/organic composite or an organic/inorganic composite. The material of the support core ball 240 is not particularly limited and may be a material that is melted at a temperature higher than about 300° C.

For example, the support core ball 240 may be a plastic core ball. In one embodiment, the support core ball 240 may include a plastic core ball including a thermosetting resin such as epoxy-based resin, melamine-formaldehyde-based resin, benzoguanamine-formaldehyde-based resin, divinylbenzene, divinylether, oligo- or polydiacrylate, or alkylene bisacrylamide resin, a plastic core including thermoplastic resin such as poly(vinyl chloride), polyethylene, polystyrene, nylon, or polyacetal resin, or an elastomeric core such as natural rubber and synthetic rubber. Furthermore, the support core ball 240 may include a plastic core formed of a mixture of thermosetting resin and thermoplastic resin.

The support core ball 240 may be formed by a polymer synthesis method. In an example, the support core 240 made of a plastic core may have a diameter of about 20 μm to about 300 μm through a synthesis method such as suspension, emulsion, or dispersion polymerization.

The support core ball 240 having a metal material may include, for example, pure Cu or a Cu alloy.

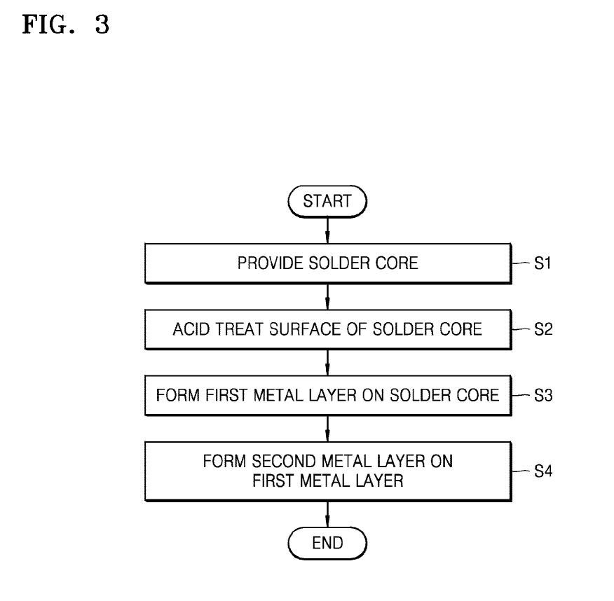

FIG. 3 is a flowchart of a method of manufacturing a solder ball for fluxless bonding according to an embodiment.

Referring to FIG. 3, the solder core 130 and 230 is provided (S1). Since the solder core 130 and 230 is described with reference to FIGS. 1 and 2, descriptions thereof are omitted.

When the solder core 130 is kept in an air atmosphere, a native oxide layer may be formed on a surface of the solder core 130. Since the native oxide layer may prevent plating, deposition, and bonding of other metal materials, the native oxide layer is removed through an acid treatment (S2).

The acid may be, for example, hydrofluoric acid, hydrochloric acid, sulfuric acid, nitric acid, phosphoric acid, or a combination thereof, but the present disclosure is not limited thereto.

Next, the first metal layer 110 and 210 is formed on the solder core 130 and 230 (S3). The first metal layer 110 and 210 may be formed by a method such as plating or deposition. In some embodiments, the first metal layer 110 and 210 may be formed by performing electrolytic plating or electroless plating.

When the first metal layer 110 and 210 is formed, a brightener may be used to improve roughness of a surface of the first metal layer 110 and 210. In other words, the first metal layer 110 and 210 having a relatively smooth surface may be obtained by using a brightener. The brightener may be, for example, an oxygen-containing organic compound such as a polyether-based compound like polyethylene glycol; a nitrogen-containing organic compound such as a tertiary amine compound or a quaternary ammonium compound; and/or a sulfur-containing organic compound having a sulfonate group, but the present disclosure is not limited thereto.

However, since bondability between the first metal layer 110 and 210 and the second metal layer 120 and 220 may be rather deteriorated due to the first metal layer 110 and 210 having a smooth surface obtained by using a brightener, the use of a brightener may be omitted during formation of the first metal layer 110 and 210.

As described above with reference to FIGS. 1 and 2, the first metal layer 110 and 210 may be a metal, for example, nickel (Ni), silver (Ag), zinc (Zn), tin (Sn), chrome (Cr), antimony (Sb), platinum (Pt), palladium (Pd), or aluminum (Al). For example, the first metal layer 110 may have a thickness of about 0.002 μm to about 0.1 μm.

Next, the second metal layer 120 and 220 is formed on the first metal layer 110 and 210 (S4). The second metal layer 120 and 220 may be formed by a method such as plating or deposition. In some embodiments, the second metal layer 120 and 220 may be formed by performing a method such as electrolytic plating or electroless plating. The second metal layer 120 and 220 may be gold (Au) or palladium (Pd) and may have a thickness of, for example, about 0.005 μm to about 0.9 μm. In some embodiments, when only the second metal layer 120 and 220 is formed without forming the first metal layer 110 and 210, the second metal layer 120 and 220 may be formed to have a thickness of equal to or greater than 0.01 μm and less than about 1 μm.

As such, after the formation of the second metal layer 120 and 220 is complete, cleaning and drying processes may be performed.

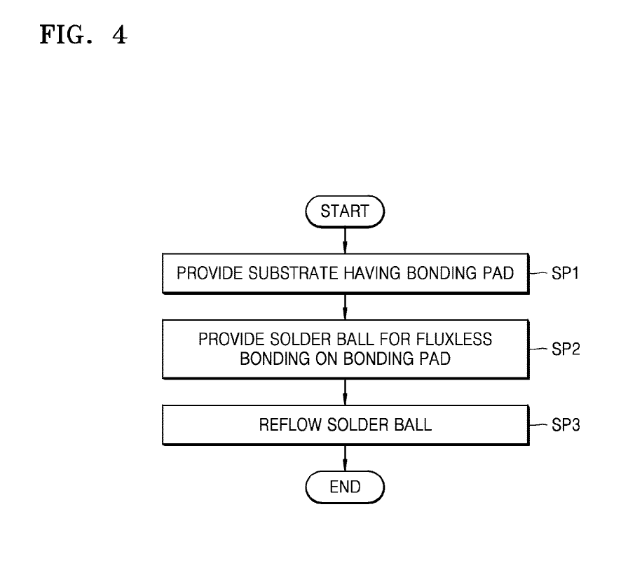

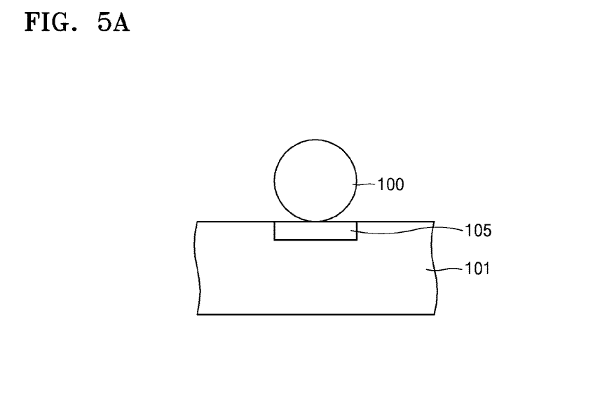

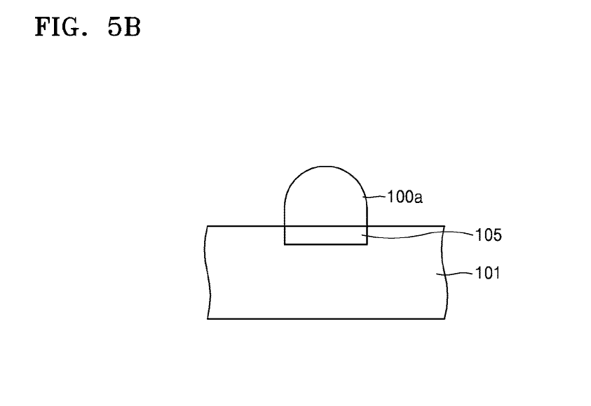

FIG. 4 is a flowchart of a method of forming a solder bump according to an embodiment. FIGS. 5A and 5B are side cross-sectional views illustrating a method of forming a solder bump according to an embodiment.

Referring to FIGS. 4 and 5A, a substrate 101 having a bonding pad 105 is provided (SP1).

The substrate 101 may be a package substrate or a semiconductor substrate. In some embodiments, the substrate 101 may be a glass substrate.

When the substrate 101 is a semiconductor substrate, the substrate 101 may include at least one of a Group III-V material and a Group IV material. The Group III-V material may be a binary, ternary, or quaternary compound including at least one of Group III elements and at least one of Group V elements. The Group III-V material may be a compound including at least one element of In, Ga, and Al, as a Group III element, and at least one element of As, P, and Sb, as a Group V element. For example, the Group III-V material may be selected from InP, In_{z}Ga_{1-z}As (0≦z≦1), and Al_{z}Ga_{1-z}As (0≦z≦1). The binary compound may be any one of InP, GaAs, InAs, InSb, and GaSb, for example. The ternary compound may any one of InGaP, InGaAs, AlInAs, InGaSb, GaAsSb, and GaAsP. The Group IV material may be Si and/or Ge. However, the Group III-V material and the Group IV material used for forming a thin film according to the technical concept of the present inventive concept are not limited to the above description.

When the substrate 101 is a package substrate, the substrate 101 may be a printed circuit board (PCB), a ceramic substrate, or an interposer. The printed circuit board may be a flexible printed circuit board (FPCB) or a rigid PCB.

When the substrate 101 is a printed circuit board, the substrate 101 may include a substrate base and the bonding pad 105 formed on at least one surface of an upper surface and a lower surface. The bonding pad 105 may be exposed by a solder resist layer covering the upper and lower surfaces of the substrate base. The substrate base may include at least one material selected from phenol resin, epoxy resin, and polyimide. For example, the substrate base may include at least one material selected from FR4, tetrafunctional epoxy, polyphenylene ether, epoxy/polyphenylene oxide, bismaleimide triazine (BT), Thermount, cyanate ester, polyimide, and liquid crystal polymer. The bonding pad 105 may include Ni/Au, Cu-OSP bare copper, ENIG, or ENEPIG. An internal wiring electrically connected to the bonding pad 105 may be formed in substrate base. The internal wiring may be formed inside the substrate base, but the present disclosure is not limited thereto and thus the internal wiring may be formed on the upper and/or lower surfaces of the substrate base to be covered by the solder resist layer. The bonding pad 105 may be a portion exposed by the solder resist layer among a circuit wiring obtained by coating copper (Cu) foil on the upper and lower surfaces of the substrate base and patterning the coated copper coil.

When the substrate 101 is an interposer, the substrate base may be formed from, for example, a silicon wafer.

Next, the solder ball 100 for fluxless bonding is provided on the bonding pad 105 (SP2). Since the solder ball 100 for fluxless bonding is described with reference to FIG. 1, a detailed description thereof is omitted. Furthermore, although FIG. 5A illustrates that the solder ball 100 for fluxless bonding of FIG. 1 is provided, the solder ball 200 for fluxless bonding of FIG. 2 may be provided instead of the solder ball 100.

Referring to FIGS. 4 and 5B, the solder ball 100 may be reflowed (SP3).

To reflow the solder ball 100, the temperature of the solder ball 100 and/or the temperature of a space where the reflow is performed are raised. When the temperature of the solder ball 100 is over a reflow temperature of the solder core 130, the solder ball 100 is deformed to be a solder bump 100a. After the solder ball 100 is sufficiently reflowed, the temperature is lowered so that the solder bump 100a may be cured.

The reflow process may be performed by heating the solder ball 100 within a temperature range of about 180° C. to about 300° C. for about 1 second to about 1 minute.

When the solder bump 100a is formed on the bonding pad 105 using the solder ball 100 or 200 for fluxless bonding, the process of applying flux to remove the native oxide layer on the surface of the solder ball 100 or 200 is unnecessary and is not performed.

When the temperature of the solder ball 100 is raised for reflow, the solder core 130 begins to melt at a melting point, for example, a temperature of about 218° C. in the case of a solder ball having a solder core of a SAC305 composition, and thus, metal layers of the first metal layer and the second metal layer are dissolved to be intermixed with the solder core.

Accordingly, the solder ball 100 may be appropriately bonded to the bonding pad 105. In detail, as the solder ball 100 having flowability has wettability with the bonding pad 105, the solder ball 100 contacts the entire upper surface of the bonding pad 105. Furthermore, a free surface side of the solder ball 100 may have a round shape to minimize surface energy, thereby forming the solder bump 100a.

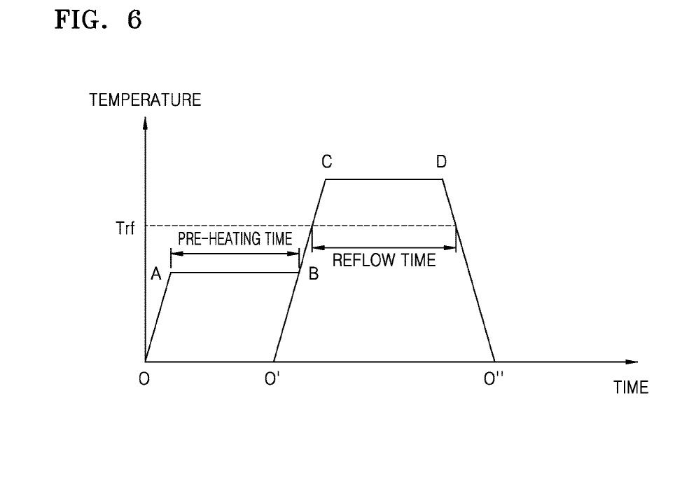

FIG. 6 is a graph showing a reflow temperature profile when using the solder ball 100 or 200 for fluxless bonding according to the embodiments and a reflow temperature profile when using a solder ball according to the related art.

Referring to FIG. 6, when the solder ball according to the related art is in use, the solder ball is reflowed along a temperature profile of a path O-A-B-C-D-O″. However, when the solder ball 100 or 200 for fluxless bonding according to the above-described embodiment is in use, the solder ball may be sufficiently reflowed along a temperature profile of a path O′-B-C-D-O″.

In detail, when the solder ball according to the related art is in use, a native oxide layer is formed on the solder ball and thus a process of providing flux to remove the native oxide layer should necessarily precede the reflow process. In the reflow process, a pre-heating time for activating the flux is required.

In other words, the temperature of the solder ball is raised to the pre-heating temperature (OA) and the pre-heating temperature is kept for a pre-heating time (AB). Flux existing on the surface of the solder ball is activated for the pre-heating time (AB) to remove the native oxide layer. After the native oxide layer is sufficiently removed, the temperature of the solder ball is raised to a temperature over a reflow temperature Trf (BC). The reflow temperature Trf is a minimum temperature at which reflow of the solder ball may occur. Accordingly, the solder ball may have flowability at the reflow temperature Trf or higher.

During the reflow time in which the temperature of the solder ball is maintained over the reflow temperature Trf, the solder ball may be reflowed. When the heating of the solder ball is stopped considering a different between the temperature of the solder ball and the reflow temperature Trf, and a cooling speed (D point), a solder bump formed through the reflow is gradually cooled and cured by being frozen at a temperature less than the reflow temperature Trf.

When the solder ball 100 or 200 for fluxless bonding according to the above-described embodiments are in use, there is no need to use flux that is expensive and thus no pre-heating time is needed and it may be sufficient to raise the temperature of the solder ball directly over the reflow temperature Trf.

In detail, at a time point O′, the temperature of the solder ball begins to increase from room temperature. Then, after the temperature of the solder ball is increased over the reflow temperature Trf (O′C), the solder ball may be reflowed for a certain time period (CD). In some embodiments, the temperature of the solder ball may linearly increase from the room temperature to the reflow temperature as time passes. Although the temperature profile in FIG. 6 is illustrated to linearly increases in a section O′C in which the temperature of the solder ball is increased, in some embodiments, the temperature may increase along a temperature profile having an upwardly convex shape. In this case, the shape of a temperature profile being upwardly convex signifies that, when certain two points on the temperature profile is connected by a straight line, the temperature profile between the points is located higher than the straight line.

A time for the solder ball remaining at a temperature over the reflow temperature Trf may be referred to as a dwell time. In other words, the time indicated to be the reflow time in FIG. 6 may be referred to as the dwell time. The solder ball may form the solder bump 100a (see FIG. 5B) by being reflowed during the dwell time.

When the solder ball according to the related art and the solder balls for fluxless bonding according to the present embodiments are compared with each other, the solder ball according to the related art requires a time OO″ for reflow, whereas the solder balls for fluxless bonding according to the present embodiments may need a time of only O′O″. Since the time OO′ required for activation of flux is as long as about ⅓ to about ½ of the total time OO″ for reflow, a considerable amount of time may be saved and high productivity may be obtained by using the solder ball for fluxless bonding according to the present inventive concept. Furthermore, production costs may be reduced because energy used for the pre-heating may be saved.

Furthermore, when flux is used, a cleaning process is separately needed to remove the flux after reflow is completed. Also, a small amount of flux may remain even after the cleaning process is performed, which may cause product corrosion.

In contrast, when the solder ball for fluxless bonding according to the present embodiments is in use, the cleaning process for removing flux may be omitted and the problem of remaining flux may be prevented.

In the following description, the structure and effect of the present inventive concept are described in detail using specific examples and comparative examples. However, the examples and the comparative examples are used merely for clear understanding of the present inventive concept, not for limiting the scope of the present inventive concept.

A first metal layer and a second metal layer were formed on a surface of tin-based lead-free solder ball having a diameter of 250 μm and including 3% Ag and 0.5% Cu, as shown in Table 1 below. When there is no metal layer corresponding to the first metal layer and the second metal layer, such a case is marked by X.

Then, a bonding performance test with respect to a Ni/Au pad finish was carried out. To carry out the bonding performance test, a solder ball was provided on a Ni/Au pad finish without applying flux thereto and then reflow was performed at 240° C. for 30 seconds.

TABLE 1

| | | | | | | | High |
|---|---|---|---|---|---|---|---|
| | 1st Metal | | 2nd Metal | | | High | Temperature, |
| | Layer | | Layer | | | Temperature | High Humidity |
| | (thickness) | | (thickness) | | Bondabillity | Discoloration | D |
| Example 1 | Ni | (0.1 μm) | Au | (0.1 μm) | bondable | X | X |
| Example 2 | Ni | (0.1 μm) | Au | (0.3 μm) | bondable | X | X |
| Example 3 | Pd | (0.1 μm) | Au | (0.1 μm) | bondable | X | X |
| Example 4 | Ni | (0.1 μm) | Au | (0.7 μm) | bondable | X | X |
| Example 5 | Ni | (0.05 μm) | Au | (0.9 μm) | bondable | X | X |
| Example 6 | Al | (0.2 μm) | Au | (0.7 μm) | bondable | X | X |
| Example 7 | Pt | (0.2 μm) | Au | (0.7 μm) | bondable | X | X |
| Example 8 | Ni | (0.2 μm) | Au | (0.7 μm) | bondable | X | X |
| Example 9 | Ni | (0.1 μm) | Au | (0.5 μm) | bondable | X | X |
| Example 10 | Al | (0.1 μm) | Au | (0.5 μm) | bondable | X | X |
| Example 11 | Pt | (0.1 μm) | Au | (0.5 μm) | bondable | X | X |
| Example 12 | X | | Au | (0.1 μm) | bondable | X | X |
| Example 13 | X | | Au | (0.7 μm) | bondable | X | X |
| Example 14 | X | | Au | (0.9 μm) | bondable | X | X |
| Comparative | X | | X | | non-bondable | Δ | ◯ |
| Example 1 | | | | | | | |
| Comparative | Ni | (0.1 μm) | Au | (1 μm) | non-bondable | X | X |
| Example 2 | | | | | | | |
| Comparative | Ni | (0.1 μm) | X | | non-bondable | ◯ | ◯ |
| Example 3 | | | | | | | |
| Comparative | Pd | (0.1 μm) | X | | non-bondable | X | X |
| Example 4 | | | | | | | |
| Comparative | Pd | (0.3 μm) | X | | weak bonding | X | X |
| Example 5 | | | | | | | |
| Comparative | X | | Au | (0.005 μm) | non-bondable | X | X |
| Example 6 | | | | | | | |
| Comparative | X | | Au | (1 μm) | non-bondable | X | X |
| Example 7 | | | | | | | |
| Comparative | Ni | (0.1 μm) | Au | (1.3 μm) | non-bondable | X | X |
| Example 8 | | | | | | | |
| Comparative | Ni | (0.3 μm) | Au | (0.9 μm) | non-bondable | X | X |
| Example 9 | | | | | | | |

According to a result of the bonding performance test, as shown in Table 1, a solder core itself where none of the first metal layer and the second metal layer exist (Comparative Example 1) was not bondable without application of flux. Furthermore, a solder ball having no second metal layer of gold (Au) on a surface thereof was not bondable (Comparative Examples 3 and 4) or, even if bonding occurred, the bonding was weak due to instability (Comparative Example 5).

When only the second metal layer (gold) was present without the first metal layer, bonding occurred well in a certain thickness range (Examples 12 to 14). However, when the thickness is excessively thick or thin departing from the thickness range, bonding did not occur (Comparative Examples 6 and 7). This is because, if the thickness of the second metal layer is excessively thin, anti-oxidation effect is low, and if the thickness of the second metal layer is excessively thick, dissolution between the solder core and the second metal layer insufficiently occurs during reflow.

Furthermore, when a sum of the thicknesses of the first metal layer and the second metal layer is excessively large (Comparative Examples 2, 8, and 9), bonding with the bonding pad was impossible. This is because, as the thicknesses of the first metal layer and the second metal layer were excessively large, the first metal layer and the second metal layer were not sufficiently dissolved with the solder core during the reflow time.

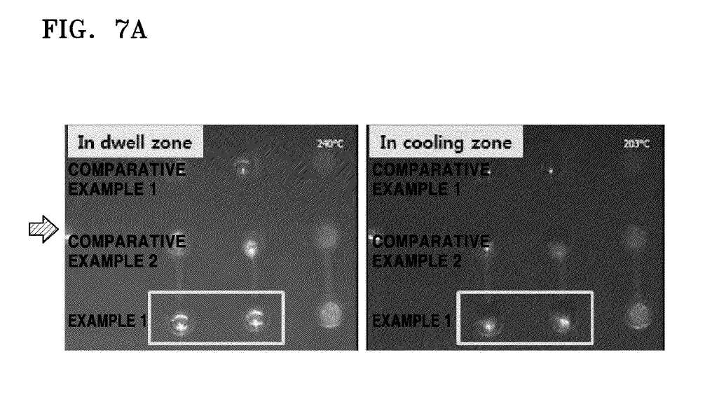

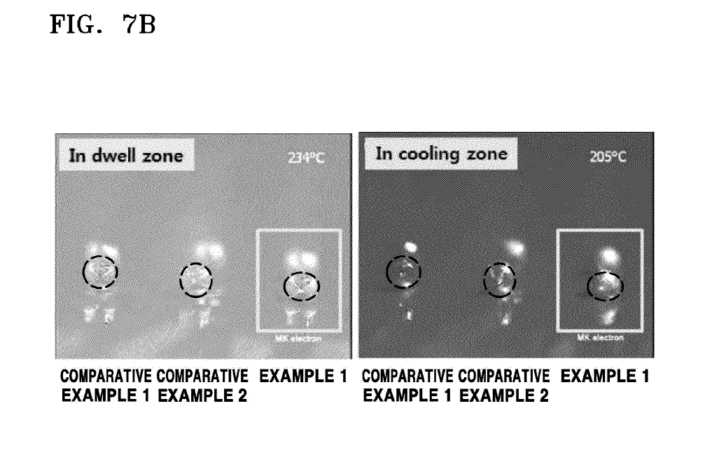

FIGS. 7A and 7B are images of solder balls according to Example 1, Comparative Example 1, and Comparative Example 2, during a dwell time in a reflow process and after cooling. In particular, FIG. 7B are images of the respective solder balls of FIG. 7A viewed in a direction along an arrow.

In Example 1, it may be seen that the solder balls were appropriately bonded to the bonding pad through the reflow process to form a solder bump having a shape that has been changed from the original circular ball shape. In Comparative Examples 1 and 2, it was observed that the solder ball almost maintained the circular ball shape and bonding was hardly performed.

Furthermore, a high temperature discoloration test was carried out to observe discoloration of the solder balls of Examples 1 to 14 and Comparative Examples 1 to 9 after the solder balls are placed at a high temperature of 125° C. for 48 hours under the atmospheric condition. The discoloration was determined by observing an initial illuminance value and an illuminance value after 48 hours. The illuminance value is measured using an illuminance measuring device and, if the illuminance value after 48 hours is changed from the initial illuminance value within a range of 0 to 2, it was determined that substantially no discoloration occurred (“X”). Also, if the illuminance value was changed within a range of 3 to 9, it was determined that discoloration occurred slightly (“A”), and if the illuminance value was changed over 10, it was determined that discoloration occurred severely (“O”).

As shown in Table 1, slight discoloration was observed from the solder ball of Comparative Example 1 where no metal layer is formed on a surface thereof, and considerably discoloration was observed from the solder ball of Comparative Example 3 where a metal layer of nickel was formed on a surface thereof. Such discoloration occurred due to oxidation and it may be seen that the metal layer of nickel was weaker to oxidation than the solder core under a normal atmospheric condition.

Furthermore, a high temperature, high humidity discoloration test was carried out with respect to the solder balls of Examples 1 to 14 and Comparative Examples 1 to 9 to observe discoloration of the solder balls after being left unattended under the condition of a high humidity of 85% and a high temperature of 125° C. for 48 hours. The illuminance value measurement method and determination method were performed in the same manner as the high temperature discoloration test.

As shown in Table 1, it may be seen that considerable discoloration occurred on the solder core (Comparative Example 1) under the high temperature and high humidity condition. In particular, referring to detailed test data, it was observed that discoloration of the solder ball of Comparative Example 1 was severer than that of the solder ball of Comparative Example 3. In detail, while the initial illuminance value of the solder ball of Comparative

Example 1 was 75, the illumination value was lowered to 43 after being left unattended for 48 hours. While the initial illuminance value of the solder ball of Comparative Example 3 was 75, the illumination value was lowered to 51 after being left unattended for 48 hours. Accordingly, it may be seen that the solder ball of Comparative Example 1 where no metal layer was formed was particularly weaker to the high humidity condition.

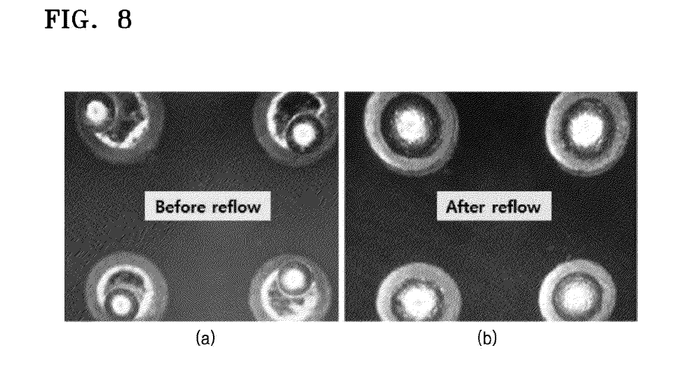

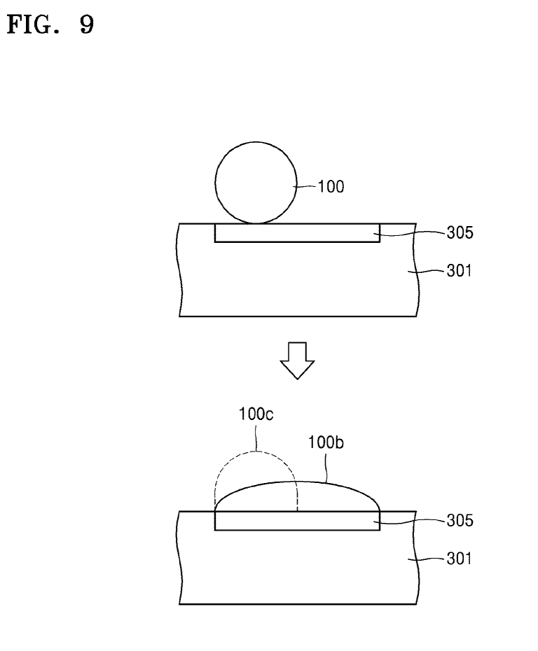

FIG. 8 is an image showing that solder balls according to an embodiment arranged on a bonding pad are normally accommodated as solder bumps after reflow. FIG. 9 is a conceptual side view showing profiles of a preferable example of a reflowed solder ball and an undesirable example of a reflowed solder ball.

Referring to (a) of FIG. 8, the solder balls of Example 1 were arranged on the respective bonding pads having a size larger than an appropriate size with respect to the size of a solder ball and the solder balls were reflowed. As a result, as shown in (b) of FIG. 8, all solder balls shows sufficient wettability to cover the entire bonding pads.

As illustrated in FIG. 9, when wettability of a solder ball is insufficient and reflow is performed on a bonding pad 305 having a relatively large size compared to the size of a solder ball, a solder bump 100c covering only a part of an upper surface of the bonding pad 305 can be obtained. In contrast, when the wettability of a solder ball is sufficient, a solder bump 100b covering the entire upper surface of the bonding pad 305 may be obtained through reflow on the bonding pad 305 having a relatively large size compared to the size of a solder ball.

Referring back to FIG. 8B, in which a solder bump covering the entire surface of the bonding pad having a relatively large size was formed after reflow, it may be seen that the solder balls according to the present embodiments have appropriate wettability.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A solder ball for fluxless bonding, the solder ball comprising:
a solder core;
a first metal layer on a surface of the solder core; and
a second metal layer on the first metal layer,
wherein the first metal layer includes at least one of nickel (Ni), silver (Ag), zinc (Zn), tin (Sn), chrome (Cr), antimony (Sb), platinum (Pt), palladium (Pd), aluminum (Al), or an alloy thereof, and wherein the second metal layer includes gold (Au).

2. The solder ball for fluxless bonding of claim 1, wherein a sum of a thickness of the first metal layer and a thickness of the second metal layer is equal to or greater than about 0.01 μm and less than about 1 μm.

3. The solder ball for fluxless bonding of claim 2, wherein the thickness of the second metal layer is equal to or greater than about 0.005 μm and equal to or less than about 0.9 μm.

4. The solder ball for fluxless bonding of claim 1, wherein a melting point of the solder core ranges from about 180° C. to about 250° C.

5. The solder ball for fluxless bonding of claim 1, further comprising a support core ball inside the solder core.

6. The solder ball for fluxless bonding of claim 5, wherein the support core ball includes a material that is not melted at a temperature of equal to or less than about 300° C.

7. A method of manufacturing a solder ball for fluxless bonding, the method comprising:
providing a solder core;
forming a first metal layer on the solder core; and
forming a second metal layer on the first metal layer, wherein the first metal layer includes at least one of nickel (Ni), silver (Ag), zinc (Zn), tin (Sn), chrome (Cr), antimony (Sb), platinum (Pt), palladium (Pd), aluminum (Al), or an alloy thereof, and wherein the second metal layer includes gold (Au).

8. The method of claim 7, further comprising treating a surface of the solder core with acid, before the forming of the first metal layer.

9. The method of claim 7, wherein a sum of a thickness of the first metal layer and a thickness of the second metal layer is equal to or greater than about 0.01 μm and less than about 1 μm.

10. The method of claim 7, wherein the forming of the first metal layer and the forming of the second metal layer are performed by electrolytic plating or electroless plating.

11. A method of forming a solder bump, the method comprising:
providing a substrate having a bonding pad;
providing a solder ball for fluxless bonding on the bonding pad; and
reflowing the solder ball for fluxless bonding,
wherein the solder ball for fluxless bonding comprises:
a solder core;
a first metal layer on a surface of the solder core; and
a second metal layer on the first metal layer,
wherein the first metal layer includes at least one of nickel (Ni), silver (Ag), zinc (Zn), tin (Sn), chrome (Cr), antimony (Sb), platinum (Pt), palladium (Pd), aluminum (Al), or an alloy thereof, and wherein the second metal layer includes gold (Au).

12. The method of claim 11, wherein flux for removing a native oxide layer is not applied to the solder ball.

13. The method of claim 11, wherein the reflowing of the solder ball for fluxless bonding is performed at a temperature ranging from about 180° C. to about 300° C. for about 1 second to about 1 minute.

14. The method of claim 13, wherein the solder bump is formed during the reflowing of the solder ball for fluxless bonding even without a pre-heating period.

15. The method of claim 13, wherein the reflowing of the solder ball for fluxless bonding comprises increasing a temperature of the solder ball from room temperature to a reflow temperature, and
wherein the temperature of the solder ball linearly increases from the room temperature to the reflow temperature in time or follows a profile having an upwardly convex shape.

16. A solder ball for fluxless bonding, the solder ball comprising:
a solder core; and
an anti-oxidation metal layer on a surface of the solder core,
wherein the anti-oxidation metal layer is a gold (Au) layer having a thickness equal to or greater than about 0.01 μm and less than about 1 μm.
